(19) United States
(12) Patent Application Publication
(10) Pub. No.: US 2016/0014439 A1
(43) Pub. Date: Jan. 14, 2016

(54) Indexing of Video Assets

(71) Applicant: Cisco Technology Inc., San Jose, CA (US)

(72) Inventors: Eric Friedrich, Somerville, MA (US); Carol ITURRALDE, Framingham, MA (US); Matt CAULFIELD, Clinton, MA (US)

(21) Appl. No.: 14/330,366

(22) Filed: Jul. 14, 2014

(51) Int. Cl. H04N 21/2343; H04N 21/643; H04N 21/234; H04N 21/654; H04N 21/231; H04N 21/232

(52) U.S. Cl. CPC H04N 21/23439; H04N 21/231; H04N 21/2323; H04N 21/23406; H04N 21/654; H04N 21/64322

(57) ABSTRACT

One embodiment of a method and system for providing multimedia content from a server to at least one client device is described. The method and system include storing a content asset in a storage unit, storing a master manifest in memory, the master manifest including information required to locate at least one format specific manifest for the content asset, the at least one format specific manifest including information for locating the content asset in a specific content format and processing the master manifest by a processor which reads the master manifest from memory, locates the at least one format specific manifest using the master manifest, and adapts the content to a desired target format on the basis of the located format specific manifest, the desired target format being appropriate for consumption by the at least one client device. Related hardware, methods and systems are also described.

### FIELD OF THE INVENTION

The present invention generally relates to adaptive bitrate streaming technologies.

### BACKGROUND OF THE INVENTION

Adaptive Bitrate (ABR) Streaming of media over a content distribution network has been widely adopted for media consumption. Various protocols for such streaming have been proposed, and are often associated with various providers of hardware or software. For example, and without limiting the generality of the foregoing, the HTTP Live Streaming (HLS) protocol has been put forth by Apple, and is typically associated with Apple devices, such as iPhones, iPads, and so forth. Likewise, the HTTP Smooth Streaming (HSS) protocol has been proposed by Microsoft, and is accordingly often associated with Microsoft products, such as Windows Phone and Silverlight. The HTTP Dynamic Streaming (HDS) protocol is associated with Adobe and Adobe products, such as Flash Player and Flash Media Server. MPEG DASH (Dynamic Adaptive Streaming over HTTP, ISO/IEC 23009-1:2012) was put forward by the MPEG standards body as yet another alternative standard adaptive bitrate protocol.

Linear streaming is a form of traditional video streaming (i.e. traditional video delivery), typically of a single bitrate asset. Linear streaming can be performed over IP, QAM modulation, Fiber, or some combination thereof. Trick playback (such as fast forward and rewind) is typically supported at multiple speeds. Linear streams can be indexed for more efficient trick playback. One such indexing format is C2, which has been standardized by ATIS and other organizations.

It is appreciated that each of these protocols may be supported on hardware or by software produced by one of these bodies, even though that particular hardware or software may be produced by one particular provider, and the adaptive bitrate format associated with a different provider. By way of example, a device running a Microsoft operating system may display streamed content which is streamed using the HDS protocol of Adobe.

### BRIEF DESCRIPTION OF THE DRAWINGS

The present invention will be understood and appreciated more fully from the following detailed description, taken in conjunction with the drawings in which:

FIG. 1 is a simplified depiction of a system in which a master manifest ties together and provides pointers to a plurality of indices for streaming content items;

FIG. 2 is a block diagram drawing of a content distribution network (CDN) in which the system of FIG. 1 may be implemented;

FIG. 3 is a block diagram drawing of a content server for use in the system of FIG. 1;

FIG. 4 is a block diagram drawing of a client media device for use in the system of FIG. 1;

FIG. 5 is a depiction of how conversion occurs between different types of indexing and storage layouts from the master manifest to various other formats in the system of FIG. 1; and

FIG. 6 is a simplified flowchart of a method of operation of the system of FIG. 1.

### DESCRIPTION OF EXAMPLE EMBODIMENTS

### Overview

A method and system for providing multimedia content from a server to at least one client device are described. The method and system include storing a content asset in a storage unit, storing a master manifest in memory, the master manifest including information required to locate at least one format specific manifest for the content asset, the at least one format specific manifest including information for locating the content asset in a specific content format and processing the master manifest by a processor which reads the master manifest from memory, locates the at least one format specific manifest using the master manifest, and adapts the content to a desired target format on the basis of the located format specific manifest, the desired target format being appropriate for consumption by the at least one client device. Related hardware, methods and systems are also described.

### Exemplary Embodiment

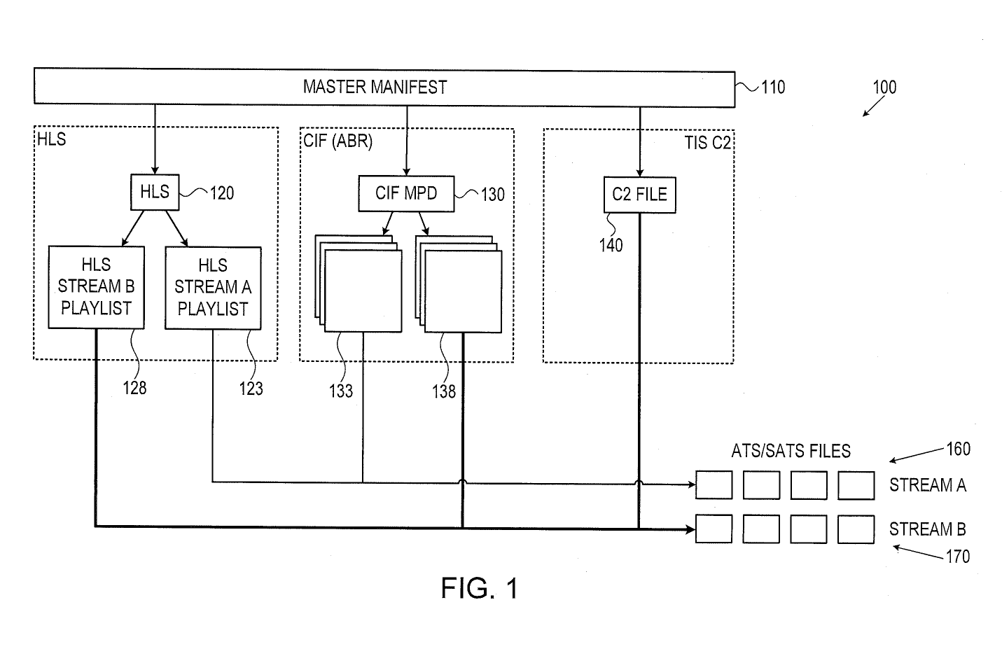

Reference is now made to FIG. 1 which is a simplified depiction of a system in which a master manifest ties together and provides pointers to a plurality of indices for streaming content items.

The adaptive bitrate (ABR) ecosystem today is fragmented, with popular formats maintained by Apple, Microsoft, and Adobe, as was already noted above. There is also an open standard (DASH) gaining popularity. Service providers are beginning to roll out large-scale ABR deployments, while simultaneously needing to maintain their existing QAM/IP streaming capabilities. Two major contributors to the costs of video streaming are the storage and delivery costs for large libraries of content.

To minimize these costs, it is desirable to have content assets stored in an intermediate format which can be converted using an on-time delivery unit, which will translate the asset from the intermediate format to an appropriate format for an end user device. This format translation will occur in an on-demand/real-time basis. Hence, the name “on-time delivery unit”, or also, in some embodiments, the name “just-in-time packager”. Ideally, a single instance of the content asset is stored, so as to reduce storage costs. The on-time delivery unit would then prepare, as needed, instances of the content asset in an appropriate format, and corresponding manifests for the content asset file format.

One such an intermediate format, developed by and commercially available from Cisco, is known as Common Intermediate Format (CIF). Video in CIF format is transmitted across a network, and translated to the end-client format at the network edge. This translation, as noted above, is performed by a just in time packager. CIF uses content stored in an MPEG2-TS-compliant, ABR-conditioned format known as Adaptive Transport Stream (ATS).

By using CIF, service providers are given the flexibility to convert to each end-client format as needed, on the fly. Using CIF enables significant storage, cache, and bandwidth savings for the service provider, or for any other user of ABR.

While ATS is preferred in some instances for QAM delivery, it is not suitable for direct delivery to ABR clients. Additionally, CIF format is (currently) a Cisco-only solution; it has not yet been standardized.

HLS is a popular ABR format, especially in view of the large number of Apple client devices in the market. HLS, if used as a common-interface format confers significant advantages over any existing proprietary CIF. Aside from gaining the simplicity and flexibility of HLS, service providers can also avoid vendor lock-in to a proprietary CIF by choosing HLS as a CIF. It is appreciated that although HLS is itself a proprietary protocol, it is also well-known, widely supported, and documented. Additionally, HLS segments are typically Transport Stream based, which is a major industry standard.

Those skilled in the art will appreciate that the terms “segment” and “fragment” are used interchangeably in the ABR realm. Typically, the term “segment” is used in discussing HLS and DASH, while the term “fragment” is used in discussions about HSS and HDS. Accordingly, the two terms “fragment” and “segment”, in all of their various forms, are understood in the present specification and claims to be used interchangeably, unless otherwise explicitly noted.

It is also appreciated that the terms “playlist” and “manifest” are used interchangeably in the ABR realm. Typically, the term “playlist” is used in discussing HLS, while the term “manifest” is used in discussions about HSS, DASH, and HDS. Accordingly, the two terms “playlist” and “manifest”, in all of their various forms, are understood in the present specification and claims to be used interchangeably, unless otherwise explicitly noted.

Service providers, in view of all of the above, see great value in having a common format, and prefer that the common format be HLS.

In the system 100 of FIG. 1, a master manifest 110 is maintained for a single HLS-formatted asset, the master manifest 110 comprising locators for multiple manifest formats: a locator for a HLS manifest 120, a locator for a CIF manifest 130, and a locator for an ATIS C2 formatted file 140. The CIF manifests 130 provide indexing needed to produce ABR end-client formats (Smooth, HDS, and DASH), while the C2 manifests 140 can be used to translation to QAM-ready format. It is appreciated that although FIG. 1 depicts the master manifest 110 as comprising locators to manifests of particular types (i.e. HLS 120, CIF 130, and C2), locators to manifests of other appropriate video formats may, in practice, be listed in the master manifest 110.

The HLS manifest 120 and the CIF manifest 130 are used for efficient production of ABR end client content by indexing decoder configuration information, encoder boundary points (EBP) locations, audio boundary locations, alternate content metadata, and DRM information. Likewise, the C2 file 140 is used for production of linear IPTV/QAM streaming by indexing decoder configuration information, encoder boundary points (EBP) locations, audio boundary locations, alternate content metadata, and DRM information. Without the indexed decoder configuration, EBP location, audio boundary location, metadata and DRM information would all have to be determined by searching through the content. By contrast, the master manifest 110 contains a path or a URL to access the HLS manifest 120, the CIF manifest 130, and the C2 manifest 140. The master manifest 110, in some embodiments, might also include basic asset information, such as title, length, date added, and version number of each of the HLS manifest 120, the CIF manifest 130, and the C2 file 140.

It is appreciated that C2 format content assets can be stored either as live content, a live content which is in the process of being converted to VOD content at the moment the content asset is requested, or as VOD content. Live content describes what is understood today as a TV channel. It may have some small (10-30 minute) replay buffer to allow for pausing, and some limited rewind/fast-forward. Rewind is limited by the size of the replay buffer and fast-forward is limited by the live point (what content is currently being broadcast). This moving forward of the beginning of the replay buffer that we describe as a “sliding” window.

Live content which is in the process of being converted to VOD content at the moment the content asset is requested takes live content but records it into a VOD. When the live content is recorded, the above mentioned small replay buffer now becomes larger. The content asset can still pause as before. However, the content asset may now be rewound all the way back to beginning of the recording, rather than being limited by the size of the replay buffer (the replay buffer does not slide, it is fixed at the beginning of the recording). As above, the content asset cannot fast-forward past the live point.

VOD content already exists in its entirety from beginning to end and it becomes available (i.e. is published) all at once. This is in contrast to live or live content which is in the process of being converted to VOD content, which becomes available over time as the program is broadcast. Rewind/Fast-forward for VOD content are not limited except at the beginning/end boundaries of the VOD.

There are several challenges associated with maintaining multiple manifests formats (and indices) for a common underlying asset:

Different storage layouts (chunked files vs. continuous file): Different end-client formats assume different storage layouts. For example, C2 140 indexing is typically produced for one large single file (which may be a few hours long for a VOD), whereas HLS 120 indexing is typically produced indexing many files (called HLS segments), each file of which is of a small duration (typically 10 seconds worth) of content. CIF 130 indexing, similar to HLS indexing, also is typically produced indexing many files of small duration.

Live vs. VOD: For live content, the format is represented as a sliding DVR window. After some fixed period of availability, the oldest content is deleted to make room for newer content. For VOD content, the format is represented as a discrete asset which may ‘grow’ at the end, but begins at a fixed point (not sliding). ATIS and other known forms of C2 140 follow this VOD model; they do not support sliding DVR windows. HLS 120 and CIF 130, by contrast typically need the content provided in the sliding window format.

In addition, the use of HLS Segments as the underlying content format means that the content has been transformed from ATS into HLS. This translation is typically lossy (i.e. information which is deemed unnecessary in the conversion process is discarded). The conversion from MPEG2-TS-compliant ATS to HLS rearranges some audio packets. This movement of audio packets causes the resulting stream to no longer be MPEG2-TS compliant and unsuitable for QAM streaming. If QAM delivery is to be preserved, additional indexing is needed in order for a just in time processor to reconstruct an MPEG2-TS-compliant transport stream (TS) suitable for consumption by QAM or IP STBs.

It is appreciated that it is possible to create HLS Segments without reordering audio frames. However, reordering results in more accurate (i.e., correct) HLS Segments and provides a seamless experience for HLS clients upshifting or downshifting on some content boundaries.

Accordingly, the master manifest 110 provides resource locators for format-specific manifests (i.e. for the HLS, CIF, or C2 formats). The master manifest 110 thereby ties assets together and provides pointers to each particular format-specific manifest.

Turning specifically to the HLS manifest 120 referenced by the master manifest 110, as is well known in ABR, different versions of playlists are made available for the same content item, so that different versions of the content are available for download at bandwidths, in accordance to media device capabilities and bandwidth availability on the network. Thus, the HLS manifest 120 which is depicted is shown as being used to generate a variety of HLS playlists (i.e. HLS Stream A Playlist 123, HLS Stream B Playlist 128). It is appreciated that there may be more than two HLS playlists which are generated from the HLS manifest 120. However, for ease of depiction, two such HLS playlists, HLS Stream A Playlist 123, HLS Stream B Playlist 128 are depicted in FIG. 1. Each one of the HLS stream playlists is then utilizable by a client device to enable the client device to use HTTP to download and display an HLS stream. By way of example, a client device which is utilizing HLS Stream A Playlist 123 will download and display Stream A 160. Likewise, a client device which is utilizing HLS Stream B Playlist 128 will download and display Stream B 170.

Turning now to the CIF media presentation description (MPD) 130, which is a data structure which describes segment information (e.g. timing, segment URL, media characteristics, such as video resolution and bitrates), is utilized to generate a variety of different playlists and manifests 133, 138, as appropriate for DASH, HSS, and HDS, reflecting various available media device capabilities and bandwidth availability on the network. One set of playlists and manifests 133 is directed to enabling downloading, and subsequently displaying Stream A 160 in a client device. Likewise, a second set of playlists and manifests 138 is directed to enabling downloading, and subsequently displaying Stream B 170 in a client device. It is appreciated that in order to use a CIF MPD 130, the client device also requires the just in time packager (as described above), which is able to convert from the CIF MPD 130 to an appropriate format, such as HSS, DASH, and HDS, as mentioned above.

Turning now to the C2 content item 140 the master manifest 110 enables construction of the file 140 for delivery according to the C2 protocol from the segments which would otherwise be used for ABR streaming video. In FIG. 1, this is depicted as the C2 file only relating to one of the two possible ABR streams, stream B 170.

The method to retrieve an asset's manifest (i.e. one of the HLS playlist, CIF MPD, and the C2 file), i.e. an entry point to the content can either be through master manifest or directly to a specific index format. That is to say that either one of the master manifest URL or the HLS Playlist URL (for example) can be provided directly to the client portal. This allows a service provider to continue to deliver HLS content to client devices without any further translation, by pointing clients directly to the HLS playlists. Additionally, service providers can deliver Smooth, HDS, DASH, QAM, or any other appropriate format by pointing the just in time packager to the master manifest.

A service provider would need to go through the just in time packager for QAM delivery despite C2 indexing already existing, because both the C2 indexing and content on disk require a translation before they could be consumed by a QAM or IP Streamer. These playout translations must account for the above-described segmentation of content on storage, remuxing of audio, and potentially stripping away of PES and TS headers (i.e. for HLS raw audio-only streams).

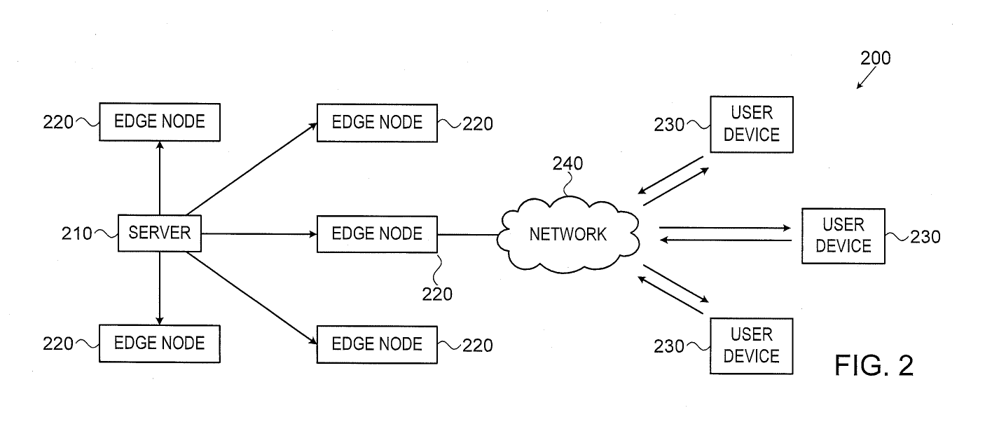

Reference is now made to FIG. 2, which is a block diagram drawing of a content distribution network (CDN) 200 in which the system of FIG. 1 may be implemented. As those skilled in the art will appreciate, the CDN 200 is typically a large distributed system of servers, such as server 210 and edge node servers 220, deployed in multiple data centers across the Internet. The CDN 200 serves content to end-users with high availability and high performance. It is also appreciated that the present invention may be implemented in other situations where content is available for adaptive bitrate (ABR) downloading and streaming. The CDN 200 is brought here as one example of such an embodiment of how the content can be served to the end user. Other non-limiting examples of such embodiments might include: a video “headend” where video processing and delivery occurs centrally, rather than being distributed to the edge of a CDN; multicast distribution over a variety of transports including cellular access networks; and an in-home network, where segments could also be transformed from HLS to target format and then distributed over WiFi.

The CDN 200 typically comprises at least the one server 210 on which large numbers of content items may be stored and served to end users' devices 230, upon demand. Typically, intermediate servers located close to end-users in the network are in communication with the server 210, and are referred to as “edge node” servers, edge nodes, or edge servers 220. Edge nodes 220 communicate with user devices 230 (sometimes referred to as client devices or client media devices), typically over a network 240.

The content asset referred to by the format specific manifest which is pointed to by the master manifest 110 (FIG. 1) may be adapted to one of a number of formats in any of the servers (i.e. the server 210 or one of the edge nodes 220) of the content distribution network 220. Typically, the method and system will be implemented in at least one of the edge nodes 220, as the edge nodes 220 are closer to the user devices 230 than the more remote server 210. Placing the master manifest 110 (FIG. 1) on the edge node maximizes savings of bandwidth and of use of cache. The master manifest 110 (FIG. 1) is transmitted once to the edge. If the master manifest 110 (FIG. 1) is used further up in the CDN (i.e. not at the edge node 220), then large multiples of the bandwidth and caching are required downstream (i.e. one copy of each file to be streamed must be stored in the edge node 220 in each of the four varieties of file formats: HLS, HDS, HSS, and DASH, as well as C2).

However the method and system may be implemented in a different server, such as server 210. Alternatively, the method and system of the present invention may also be implemented at a home gateway or a client device. For ease of discussion and depiction, all further discussion will be directed to the edge node 220 as the server which provides the master manifest 110 (FIG. 1).

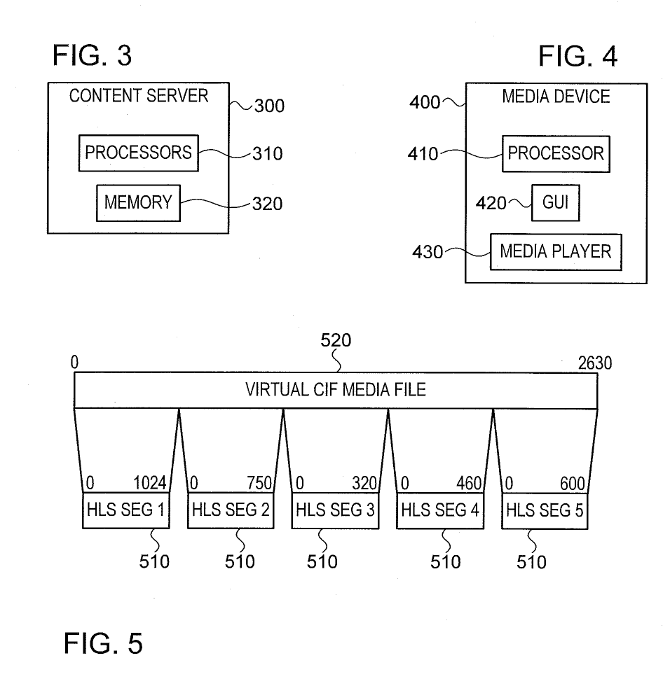

Reference is now made to FIG. 3, which is a block diagram drawing of a content server 300 for use in the system of FIG. 1. The content server 300 may comprise the one of the edge nodes 220 or the server 210 of FIG. 2. Alternatively, the content server 300 may be any other device operative, such as a home gateway, to serve as an adaptive bitrate content server in order to stream said content to a user device 230 (FIG. 2).

The content server 300 comprises storage (not depicted), which stores the content file, either as segments adapted for ABR streaming, or as a complete file, which is ready for QAM delivery. The master manifest 110 (FIG. 1) is typically also stored in the storage.

The content server 300 comprises at least one processor 310, and may comprise more than one processor 310. One of the processors 310 may be a special purpose processor operative as described herein, to perform the adaptation of the content asset referred to by the format specific manifest which is pointed to by the master manifest 110 (FIG. 1) to one of: HLS format; HSS format; HDS format; MPEG DASH format; and a content output format which is linear MPEG2-TS, intended for linear or QAM streaming, indexed in the C2 format. In addition, the content server 300 comprises a non-transitory computer-readable storage medium (i.e. memory) 320. The memory 320 may store instructions, which at least one of the processors 310 may execute, in order to perform the adaptation of the content asset referred to by the format specific manifest which is pointed to by the master manifest 110 (FIG. 1) to one of HLS, HSS, HDS, MPEG DASH, and C2 formats, described herein. Content server 300 also comprises typical and standard hardware and software components as are known in the art.

In an embodiment of the present invention, the processor 310 reads the master manifest into memory 320, locates one of the HLS, HSS, HDS, MPEG DASH, and C2 formats and their respective manifests, and finally outputs the requested content in the desired format.

Reference is now made to FIG. 4, which is a block diagram drawing of a client media device 400 for use in the system of FIG. 1. The client media device 400 may be an instance of one of the user devices 230 of FIG. 2. Typical implementations of the client media device 400 include, but are not limited to, a tablet device, smartphone, desktop or portable computer, set-top box, Internet-enabled television, media center PC, or any other suitable device, such as is known in the art.

The media device 400 comprises at least one processor 410, a user interface (typically a graphical user interface, GUI) 420, and a media player 430. The media player may comprise a player adapted as one of: an ABR player; a QAM player; or the player may be adapted to play content which delivered as one of ABR formatted content and QAM formatted content. Alternatively, the media device 400 may comprise two players, one for content delivered as ABR format content and one for content delivered as QAM format content. In yet another alternative embodiment, the media device 400 may comprise an IPTV player, optimized for UDP or RTP streaming.

The GUI 420 and the media player 430 may comprise a single application, may be two applications which interact with each other, or the GUI may be part of a different application, such as a Web browser. The GUI 420 enables a user of the media device 400 to interact with the media player 430, in order to request content; to execute start, stop, and pause of the media player 430; and to perform other well-known typical user interactions with the media player 430.

The media device may comprise more than one processor 410. One of the processors 410 may be a special purpose processor operative to perform the location, based on the master manifest 110 (FIG. 1), of one of HLS, HSS, HDS, MPEG DASH, and linear formats (such as, but not limited to C2), according to the method described herein. In addition, the client media device 400 comprises non-transitory computer-readable storage media (i.e. memory—not depicted). The memory may store instructions, which at least one of the processors 410 may execute, in order to perform the method of location, based on the master manifest 110 (FIG. 1), of one of HLS, HSS, HDS, MPEG DASH, and linear formats, described herein. Client media device 400 also comprises typical and standard hardware and software components as are known in the art.

Reference is now made to FIG. 5, which is a depiction of how conversion occurs between different types of indexing and storage layouts from the master manifest to various other formats in the system of FIG. 1. As was noted above, different index formats describe content which is stored in different layouts. A C2 index file describes a single large video file, while HLS and CIF describe a series of chunked video files. As such, a C2 index file typically describes a file which is delivered as a “sliding window”, in which the file beginning and end are always available. Typically there is no such sliding window for video-on-demand (VoD) content formatted files, such as the HLS and CIF files.

When content is stored in segmented form 510 and an index describes content stored in continuous form, metadata is added to the indexing to indicate which file an index record refers to. This added metadata may consist of filenames explicitly added to the indexing, or creating a logically continuous asset 520. A logical continuous asset 520 is a virtual concatenation of all segments. The indexing (such as C2 indexing) then describes the logical asset.

For example, assume HLS Segment 1 (labeled HLS Seg1 in FIG. 5) is 1 MB in total size. Further assume that there is I-frame data which needs to be indexed 0.2 MB from the beginning of the succeeding HLS Segment 2 (labeled HLS Seg2 in FIG. 5). An I-frame index record will be created which describes the data at 1.2 MB from the beginning of the logical asset 520. Similarly, combining the following HLS segments 3-5 (labeled HLS Seg3-5 in FIG. 5) into the logical asset 520 HLS Segment would result in a logical asset 520 of length 2.5 MB.

On the other hand, for linear content that is stored as a sliding window, the offset of the beginning of the window needs to be stored as well. Continuing the same example from above, after HLS segment 1 is removed from the live window, HLS segment 2 is now the first segment. Storing an indication that HLS segment 2 starts at 1 MB into the logical continuous asset removes the need to otherwise update all index records when a segment is removed from the live window.

Alternately, the index can be created relative to the start of each segment. This may require structural changes to the index file, which would necessitate a further index translation on playout. That is to say that instead of a single index file, there might be multiple index files, each index file referring to only one specific ABR segment.

When content is stored in continuous form (for example, the asset 520 is an actual asset, and not a logical asset) and index formats are indexes of content which is segmented, it may be necessary to extend the indexing to use byte ranges which are indicative of an offset from the beginning of the continuous file inside the content in addition to file names.

Further, the index format may need to be enhanced to represent more details about the storage format of the content. For instance, the index may indicate that the audio been remuxed to provide a better playout experience at some boundaries. Thus, the index format may include a global indication, such as a Boolean flag, or an attribute in the index indicating that the entire piece of content has remixed audio. Alternatively, a more granular indication of remuxing on a per-segment basis may be called for if not every segment of the content was audio remixed.

On playout, this audio metadata will be used to determine if the stream must be re-multiplexed in order for it to be MPEG2-TS compliant.

An exemplary master manifest is provided below. The master manifest, as will be seen, is very simple, and references other, more complex, playlists (i.e. an HLS playlist; a CIF playlist; and a C2 index file):

Title: CSI Miami
Date Added: June 4, 2014
Length: 42 minutes
HLS Playlist: http://example.com/hls/CSI_Miami.m3u8
C2 Index: http://example.com/c2/CSI_Miami.c2
CIF Index: /mnt/nas/CSI_Miami.cif

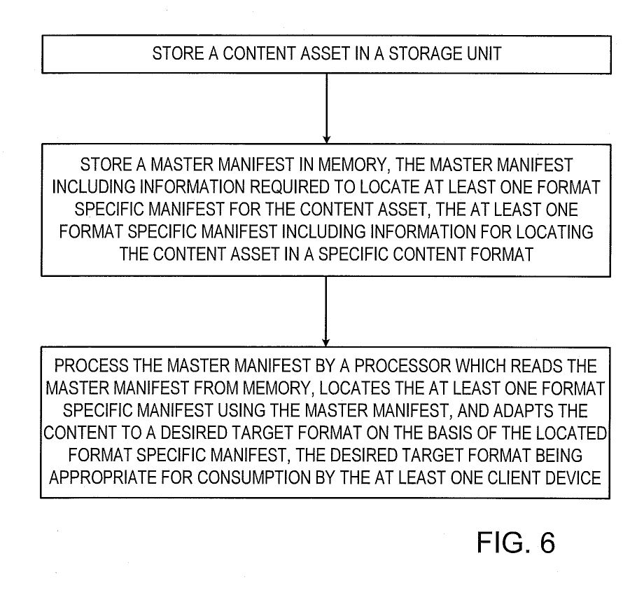

Reference is now made to FIG. 6, which is a simplified flowchart of a method of operation of the system of FIG. 1. The method of FIG. 6 is believed to be self-explanatory with reference to the above discussion.

It is appreciated that software components of the present invention may, if desired, be implemented in ROM (read only memory) form. The software components may, generally, be implemented in hardware, if desired, using conventional techniques. It is further appreciated that the software components may be instantiated, for example: as a computer program product or on a tangible medium. In some cases, it may be possible to instantiate the software components as a signal interpretable by an appropriate computer, although such an instantiation may be excluded in certain embodiments of the present invention.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited by what has been particularly shown and described hereinabove. Rather the scope of the invention is defined by the appended claims and equivalents thereof:

What is claimed is:

1. A system for providing multimedia content from a server to at least one client device, the system comprising:
a storage unit which stores a content asset;
a master manifest stored in memory, the master manifest comprising information required to locate at least one format specific manifest for the content asset, the at least one format specific manifest comprising information for locating the content asset in a specific content format; and
a processor which reads the master manifest from memory, locates one format specific manifest using the master manifest, and adapts the content to a desired target format on the basis of the located format specific manifest, the desired target format being appropriate for consumption by the at least one client device.

2. The system according to claim 1 wherein the format specific manifest comprises one of:
an HTTP Live Streaming (HLS) manifest;
a Common Interface media presentation description (CIF MPD) manifest; and
a linear video on demand manifest.

3. The system according to claim 2 wherein the linear video on demand manifest comprises a C2 manifest.

4. The system according to claim 2 wherein the linear video on demand is delivered over an IP network.

5. The system according to claim 2 wherein the linear video on demand is delivered via QAM modulation.

6. The system according to claim 2 wherein the linear video on demand is delivered over a Fiber network.

7. The system according to claim 2 wherein the outputted CIF MPD manifest is further used to generate a manifest for another adaptive bitrate streaming format.

8. The system according to claim 1 wherein the master manifest comprises references to a location of the at least one format specific manifest.

9. The system according to claim 1 wherein the content asset comprises a plurality of segments which, when taken together, comprise a complete instance of the content asset.

10. The system according to claim 9 wherein the plurality of segments are logically combined to form a single logical instance of the content asset.

11. The system according to claim 1 wherein the content asset comprises a single file which may be logically segmented to produce segments for one of HLS and CIF streaming.

12. The system according to claim 11 wherein the segments produced include indexes using byte ranges which are indicative of an offset from a beginning of the single file inside the content asset.

13. A method for providing multimedia content from a server to at least one client device, the system comprising:
storing a content asset in a storage unit;
storing a master manifest in memory, the master manifest comprising information required to locate at least one format specific manifest for the content asset, the at least one format specific manifest comprising information for locating the content asset in a specific content format; and
processing the master manifest by a processor which reads the master manifest from memory, locates the at least one format specific manifest using the master manifest, and adapts the content to a desired target format on the basis of the located format specific manifest, the desired target format being appropriate for consumption by the at least one client device.

14. The method according to claim 13 wherein the format specific manifest comprises one of:
an HTTP Live Streaming (HLS) manifest;
a Common Interface media presentation description (CIF MPD) manifest; and
a linear video on demand manifest.

15. The method according to claim 14 wherein the linear video on demand manifest comprises an C2 manifest.

16. The method according to claim 14 wherein the linear video on demand is delivered by one of: an IP network; via QAM modulation; and a Fiber network.

17. The method according to claim 14 wherein the outputted CIF MPD manifest is further used to generate a manifest for another adaptive bitrate streaming format.

18. The method according to claim 13 wherein the master manifest comprises references to a location of the at least one format specific manifest.

19. The method according to claim 13 wherein the content asset comprises a plurality of segments which, when taken together, comprise a complete instance of the content asset.

20. A system for providing multimedia content from a server to at least one client device, the system comprising:
means for storing a content asset in a storage unit;
means for storing a master manifest in memory, the master manifest comprising information required to locate at least one format specific manifest for the content asset, the at least one format specific manifest comprising information for locating the content asset in a specific content format; and
means for processing the master manifest by a processor which reads the master manifest from memory, locates the at least one format specific manifest using the master manifest, and adapts the content to a desired target format on the basis of the located format specific manifest, the desired target format being appropriate for consumption by the at least one client device.
